(19) United States
(12) Patent Application Publication
(10) Pub. No.: US 2021/0165377 A1
(43) Pub. Date: Jun. 3, 2021

(54) METHOD FOR CONTROLLING COMMERCIAL WASHING MACHINE BY USING ARTIFICIAL INTELLIGENCE AND SYSTEM FOR THE SAME

(71) Applicant: LG ELECTRONICS INC., Seoul (KR)

(72) Inventors: Yoosool YOON, Seoul (KR); Seongmi HWANG, Seoul (KR)

(73) Assignee: LG ELECTRONICS INC., Seoul (KR)

(21) Appl. No.: 17/075,405

(22) Filed: Oct. 20, 2020

(30) Foreign Application Priority Data
Nov. 29, 2019 (KR) 10-2019-0157412

(51) Int. Cl. G05B 19/042; G06N 20/00; H04L 29/08; D06F 34/04; D06F 31/00; D06F 34/28

(52) U.S. Cl. CPC G05B 19/042; G06N 20/00; H04L 67/10; D06F 2105/50; D06F 31/00; D06F 34/28; G05B 2219/2633; D06F 34/04

(57) ABSTRACT

Disclosed are a method for controlling a commercial washing machine by using artificial intelligence and a system for the same. The method for controlling a commercial washing machine by using artificial intelligence comprises: a step of receiving a request for use of a plurality of commercial washing machines connected to each other through a network from a user through a user terminal; a step of transmitting the request for use to a cloud server; a step in which the cloud server selects an available one of the plurality of commercial washing machines for the request for use and sets the commercial washing machine to a standby state; and a step in which the cloud server provides the user with a recommended washing course created based on a user's use history of the plurality of commercial washing machines.

### CROSS REFERENCE TO RELATED APPLICATION

Pursuant to 35 U.S.C. § 119(a), this application claims the benefit of earlier filing date and right of priority to Korean Patent Application No. 10-2019-0157412, filed Nov. 29, 2019, the contents of which are all hereby incorporated by reference herein in its entirety.

### BACKGROUND OF THE INVENTION

### Field of the Invention

The present disclosure relates to a method for controlling a commercial washing machine by using artificial intelligence and a system for the same, and more particularly to a method for controlling a commercial washing machine capable of creating a standby state or a recommended washing course, and a system for the same.

### Description of the Related Art

With the development of technologies, apparatuses equipped with artificial intelligence (AI) are being widely introduced. Particularly, a commercial appliance to which an Internet of Things (IoT) technology is applied to be connected to networks is also implemented to have AI.

A commercial washing machine is installed in a public place for use by a large number of unspecified users. A user who wants to use visits a launderette having the commercial washing machine installed therein, pays a fee for it and starts to use it.

As described above, since the commercial washing machine can be used by many and unspecified persons, a user may not be able to use the washing machine because all the washing machines are being used when the user visits the launderette. In this case, the user has to visit another launderette or has to wait until another user finishes using the washing machine.

As such, a user may not be able to use the commercial washing machine unexpectedly or may have a hard time in operating an unfamiliar washing machine in another launderette instead of a launderette that the user usually visits. For the purpose of preventing user inconvenience that occurs in such cases, various technologies for controlling the commercial washing machine are proposed.

### SUMMARY OF THE INVENTION

The purpose of the present disclosure is to provide a method for controlling a commercial washing machine by using artificial intelligence.

The purpose of the present disclosure is to provide a control system for a commercial washing machine by using artificial intelligence.

The technical problem to be overcome by the present disclosure is not limited to the above-mentioned technical problems. Other technical problems not mentioned can be clearly understood from the following descriptions of the present disclosure by a person having ordinary skill in the art.

One embodiment is a method of a server for controlling a plurality of commercial washing machines connected through network by using artificial intelligence. The method includes: receiving, from a user terminal, a request for use of a commercial washing machine; selecting an available one of the plurality of commercial washing machines in response to the request for use; setting the selected commercial washing machine to a standby state; and providing the user terminal with a recommended washing course created based on a user's use history of the plurality of commercial washing machines.

In various embodiments of the present disclosure, the method may further includes authenticating the user terminal by logging into a user account registered in the cloud server in order to receive the request for use of a commercial washing machine, wherein the user account stores the user's use history of the plurality of commercial washing machines.

In various embodiments of the present disclosure, the user account further stores a use history of a household washing machine possessed by the user and the recommended washing course is generated further based on the user's use history of the household washing machine.

In various embodiments of the present disclosure, the plurality of commercial washing machines may include a plurality of commercial washing machines located at different spaces. The use history of the plurality of commercial washing machines may include a use history of the plurality of commercial washing machines located at different spaces.

In various embodiments of the present disclosure, selecting of an available one of the plurality of commercial washing machines includes receiving location information of the user terminal; and selecting an available one of the commercial washing machines located closest to the user terminal among the plurality of commercial washing machines located at different spaces.

In various embodiments of the present disclosure, the providing the user terminal with a recommended washing course includes extracting at least one feature from among a washing process, a washing time, and an amount of detergent comprised in the user's use history of the commercial washing machine; and creating the recommended washing course from the extracted features.

In various embodiments of the present disclosure, the method may further include controlling the standby commercial washing machine by using control commands based on the recommended washing course.

In various embodiments of the present disclosure, the method may further include releasing a locked state of the commercial washing machine by using the user terminal in order to control the standby commercial washing machine.

Another embodiment is a control system for a plurality of commercial washing machines by using artificial intelligence. The control system includes: a plurality of commercial washing machines connected through a network; and a cloud server configured to receive a request for use of the plurality of commercial washing machines from a user, select an available one of the plurality of commercial washing machines, and set the commercial washing machine to a standby state. The cloud server may include a storage which stores a user's use history of the plurality of commercial washing machines; and a processor which creates a recommended washing course based on the user's use history of the plurality of commercial washing machines.

In various embodiments of the present disclosure, the storage may store a user account into which the user logs in order to provide the request for use of the plurality of commercial washing machines. The user account stores the user's use history of the commercial washing machine.

In various embodiments of the present disclosure, the user account may store a user's use history of a household washing machine. The processor may create the recommended washing course with reference to the user's use history of the household washing machine and the user's use history of the plurality of commercial washing machines.

In various embodiments of the present disclosure, the processor may extract at least one feature from among a washing process, a washing time, and an amount of detergent comprised in the user's use history of the washing machine, and may create the recommended washing course from the extracted features.

In various embodiments of the present disclosure, the plurality of commercial washing machines may include a plurality of commercial washing machines located at different spaces. The use history of the plurality of commercial washing machines may include a use history of the plurality of commercial washing machines located at different spaces.

In various embodiments of the present disclosure, the control system may further include a user terminal which transmits the request for use of the plurality of commercial washing machines to the cloud server based on an input of the user. The user terminal may include a display unit which outputs details by receiving the recommended washing course from the cloud server.

In various embodiments of the present disclosure, the user terminal may control the driving of the washing machine by receiving the input of the user and by transmitting control commands based on the recommended washing course to the standby commercial washing machine.

In various embodiments of the present disclosure, the standby commercial washing machine may be locked, and the user terminal may perform user authentication, and thus release the locked state of the commercial washing machine.

In various embodiments of the present disclosure, the user terminal may provide location information of the user to the cloud server. An available one of the commercial washing machines located closest to the user among the plurality of available commercial washing machines located at different spaces based on the location information of the user may be set to a standby state by the cloud server.

Other embodiments of the present invention are included in description in detail and accompanying drawings.

According to a method for controlling a commercial washing machine by using artificial intelligence and a system for the same in accordance with the embodiments of the present disclosure, use of the commercial washing machine to be used is reserved through a cloud server in response to a user's request for use. Therefore, through this, it is possible to increase the convenience of a user who wants to use the commercial washing machine and to improve user experience.

Also, the cloud server may create and provide a recommended washing course applicable to the commercial washing machine to the user. Since the recommended washing course is created based on a user's past use history of a commercial washing machine or a household washing machine, it is possible to provide a recommended washing course suitable for use habit of the user.

Advantageous effects of the present disclosure are not limited to the above-described effects and other unmentioned effects can be clearly understood from the description of the claims by those skilled in the art to which the present disclosure belongs.

### BRIEF DESCRIPTION OF THE DRAWINGS

FIG. 1 is a view for describing a control system for a commercial washing machine by using artificial intelligence in accordance with some embodiments of the present disclosure;

FIG. 2 is a view for describing a user terminal included in the control system for a commercial washing machine by using artificial intelligence in accordance with some embodiments of the present disclosure;

FIG. 3 is a view for describing a server included in the control system for a commercial washing machine by using artificial intelligence in accordance with some embodiments of the present disclosure;

FIG. 4 is a view for describing a commercial washing machine which is controlled by the control system for the commercial washing machine by using artificial intelligence in accordance with some embodiments of the present disclosure;

FIG. 5 is a flowchart for describing a method for controlling a commercial washing machine by using artificial intelligence in accordance with some embodiments of the present disclosure;

FIG. 6 is a view for describing that the control system for a commercial washing machine by using artificial intelligence in accordance with some embodiments of the present disclosure sets the commercial washing machine to a standby state;

FIG. 7 is a view for describing that the control system for a commercial washing machine in accordance with some embodiments of the present disclosure creates a recommended washing course;

FIG. 8 is a flowchart for describing the method for controlling a commercial washing machine in accordance with some embodiments of the present disclosure; and

FIG. 9 is a data flowchart for describing the method for controlling a commercial washing machine by using artificial intelligence in accordance with some embodiments of the present disclosure.

### DETAILED DESCRIPTION OF THE INVENTION

Also, in the following description of the embodiment disclosed in the present specification, the detailed description of known technologies incorporated herein is omitted to avoid making the subject matter of the embodiment disclosed in the present specification unclear. Also, the accompanied drawings are provided only for more easily describing the embodiment disclosed in the present specification. The technical spirit disclosed in the present specification is not limited by the accompanying drawings. All modification, equivalents and substitutes included in the spirit and scope of the present invention are understood to be included in the accompanying drawings. Hereinafter, embodiments disclosed in this specification will be described in detail with reference to the accompanying drawings. The same or similar elements will be denoted by the same reference numerals irrespective of drawing numbers, and repetitive descriptions thereof will be omitted. A suffix “module” and “part” for the component, which is used in the following description, is given or mixed in consideration of only convenience for ease of specification, and does not have any distinguishing meaning or function per se.

While terms including ordinal numbers such as the first and the second, etc., can be used to describe various components, the components are not limited by the terms mentioned above. The terms are used only for distinguishing between one component and other components.

In the case where a component is referred to as being “connected” or “accessed” to another component, it should be understood that not only the component is directly connected or accessed to the other component, but also there may exist another component between them. Meanwhile, in the case where a component is referred to as being “directly connected” or “directly accessed” to another component, it should be understood that there is no component therebetween.

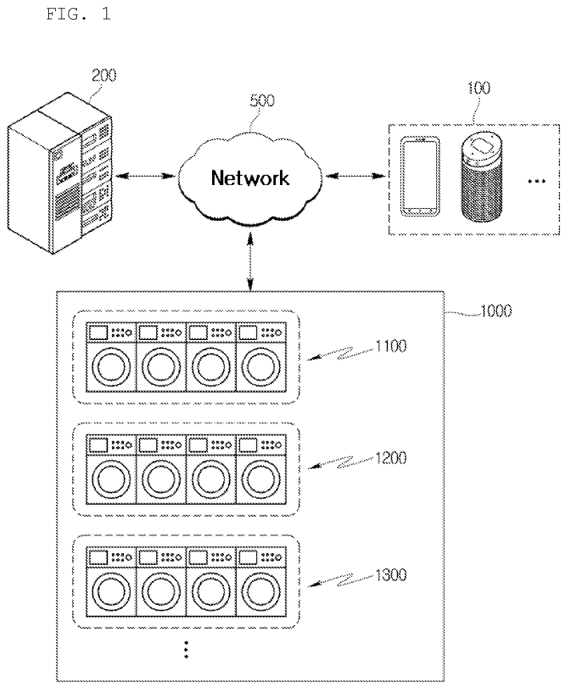

FIG. 1 is a view for describing a control system for a commercial washing machine by using artificial intelligence in accordance with some embodiments of the present disclosure.

Referring to FIG. 1, the control system for a commercial washing machine may include a user terminal 100 for controlling a commercial washing machine 1000, a plurality of the commercial washing machine 1000 connected to each other through a network 500, and a cloud server 200 which receives and processes a request for use of the plurality of commercial washing machines 1000 from a user.

The user terminal 100 may include, for example, a cellular phone, a smartphone, a tablet PC, an ultra-book, a wearable device (e.g., a smart watch, a smart glass, and a head mounted display (HMD)), etc.

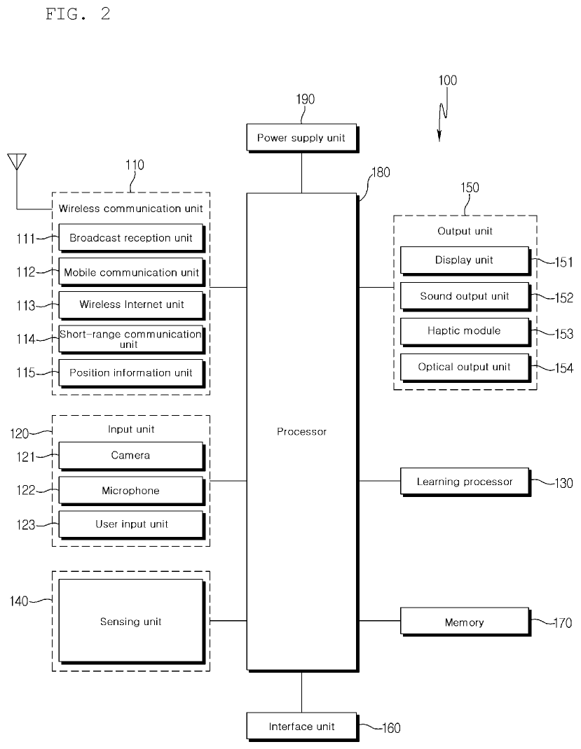

The user terminal 100 will be described later in more detail with reference to FIG. 2.

In regard to an artificial intelligence model described in the embodiment of the present disclosure, the cloud server 200 may serve to provide the user terminal 100 with various services to which the artificial intelligence model is applied.

The cloud server 200 included in the control system for a commercial washing machine according to some embodiments of the present disclosure may use artificial intelligence (AI) in connection with the creation of standby and a recommended washing course of the commercial washing machine.

Artificial intelligence refers to the field of studying artificial intelligence or methodology for making artificial intelligence, and the machine learning refers to the field of defining various issues dealt with in the field of artificial intelligence and studying methodology for solving the various issues. The machine learning is defined as an algorithm that enhances the performance of a certain task through steady experience with the certain task.

The artificial neural network (ANN) is a model used in machine learning and may mean a whole model which has a problem-solving ability and is composed of artificial neurons (nodes) that form a network by synaptic connections. The artificial neural network may be defined by a connection pattern between neurons of different layers, a learning process for updating model parameters, and an activation function for generating an output value.

The artificial neural network may include an input layer, an output layer, and optionally one or more hidden layers. Each layer may include one or more neurons, and the artificial neural network may include a synapse that links neurons to neurons. Each neuron in the artificial neural network may output a function value of the activation function for input signals, a weight, and a bias input through the synapse.

The model parameters mean parameters determined by learning, and include the weight of the synaptic connections and bias of neurons, etc. In addition, a hyper parameter means a parameter to be set before learning in the machine learning algorithm, and includes a learning rate, the number of times of the repetition, a mini batch size, an initialization function, and the like.

The purpose of the learning of the artificial neural network is regarded as determining a model parameter that minimizes a loss function. The loss function may be used as an index for determining an optimal model parameter in the learning process of the artificial neural network.

The machine learning may be classified into supervised learning, unsupervised learning, and reinforcement learning based on a learning method.

The supervised learning may refer to a method of training the artificial neural network in a state in which a label for learning data is given. The label may mean a correct answer (or a result value) that the artificial neural network must infer when the learning data is input to the artificial neural network. The unsupervised learning may refer to a method of training the artificial neural network in a state in which a label for learning data is not given. The reinforcement learning may refer to a learning method of training an agent defined in a certain environment to select a behavior or a behavior sequence that maximizes the cumulative reward in each state.

Machine learning, which is implemented by a deep neural network (DNN) including a plurality of hidden layers of the artificial neural networks, is called deep learning, and the deep learning is part of the machine learning. Hereinafter, the machine learning is used as a meaning including the deep running.

Also, the user terminal 100 which performs a method for controlling a commercial washing machine in accordance with some embodiments of the present disclosure can use the above-described artificial intelligence as well.

In this specification, the cloud server 200 is described as referring to a set of computers installed through the network 500 in a place other than a place where the plurality of commercial washing machines 1000 are installed. However, the cloud server 200 of the present disclosure is not limited to such a technical concept, and the server 200 may include a device such as a home server, a home hub, or a home gateway, etc., installed in a launderette with the plurality of commercial washing machines 1000 installed therein.

The plurality of commercial washing machines 1000 are installed such that a user who has visited the launderette pays a fee and washes laundry. In various embodiments of the present disclosure, the plurality of commercial washing machines 1000 may include commercial washing machines 1100, 1200, and 1300 located at different spaces. For example, first plurality of commercial washing machines 1100 may be installed in a first launderette, second plurality of commercial washing machines 1200 may be installed in a second launderette, and third plurality of commercial washing machines 1300 may be installed inf a third launderette.

The plurality of commercial washing machines 1000 may be in a standby state by being reserved for use by the cloud server 200 connected through the network 500. Here, the standby state means that the power of the commercial washing machine is turned on and the commercial washing machine can perform a washing operation by user inputs.

The standby commercial washing machine among the plurality of commercial washing machines 1000 may perform the washing operation through the operation of a button unit by the user. Also, when the user provides a control command through the user terminal 100, the commercial washing machines 1000 in a standby state may start washing by the control command transmitted from the cloud server 200.

The network 500 is a wired network and a wireless network, such as a local area network (LAN), a wide area network (WAN), the Internet, intranet and extranet, and a mobile network, for example, a cellular network, 3G network, LTE network, 5G network, Wi-Fi network, ad hoc network, and any suitable communication network including a combination thereof.

The network 500 may include connections of network elements such as hubs, bridges, routers, switches, and gateways. The network 500 may include one or more connected networks, for example, a multiple network environment, including a public network such as the Internet, and a private network such as a secure enterprise private network. Access to the network 500 may be provided through one or more wired or wireless access networks. The user terminal 100 may transmit and receive data with the cloud server 200, i.e., a learning device through a 5G network. The user terminal 100 can perform a data communication with the cloud server 200 by using at least one service among Enhanced Mobile Broadband (eMBB), Ultra-Reliable and Low Latency Communications (URLLC), and Massive Machine-Type Communications (mMTC) through a 5G network.

The Enhanced Mobile Broadband (eMBB) is a mobile broadband service through which multimedia contents, wireless data access, etc., are provided. Also, more advanced mobile services such as hot spot, broadband coverage, etc., for accommodating explosively increasing mobile traffic may be provided through the eMBB. A large amount of traffic may be accommodated in an area with a low user mobility and high density through the hot spot. The broadband coverage can ensure a wide and stable wireless environment and user mobility.

The Ultra-Reliable and Low Latency Communications (URLLC) service defines much more stringent requirements than those of an existing LTE in terms of reliability of data transmission and reception and transmission delay. 5G service for production process automation in industrial sites and for telemedicine, telesurgery, transportation, safety, etc., correspond to the URLLC service.

The Massive Machine-Type Communications (mMTC) is a service that is not sensitive to the transmission delay, which requires a relatively small amount of data transmission. The mMTC enables much more terminals such as sensors than general cellular phones to access the wireless access network at the same time. In this case, the terminal should have a low communication module price and requires an improved power efficiency and a power saving technology such that it can operate for several years without battery replacement or recharging.

FIG. 2 is a view for describing the user terminal 100 capable of performing the method for controlling a commercial washing machine by using artificial intelligence in accordance with some embodiments of the present disclosure.

Referring to FIG. 2, the user terminal 100 may include a wireless communication unit 110, an input unit 120, a learning processor 130, a sensing unit 140, an output unit 150, and an interface unit 160, a memory 170, a processor 180, and a power supply 190.

The user terminal 100 according to the embodiment of the present disclosure may perform a function of a control equipment which controls the plurality of commercial washing machines 1000. The commercial washing machine 1000 may receive control commands through the user terminal 100 and may perform operations according to the control commands.

The wireless communication unit 110 may include at least one of a broadcast reception unit 111, a mobile communication unit 112, a wireless internet unit 113, a short-range communication unit 114, and a position information unit 115.

The broadcast reception unit 111 may receive a broadcast signal and/or broadcast related information from an external broadcast management server through a broadcast channel.

The mobile communication unit 112 may transmit and receive a radio signal with at least one of a base station, an external terminal, a server on a mobile communication network built according to technical standards or communication methods for mobile communication (e.g., Global System for Mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like). However, the present disclosure is not limited to the examples of the above-mentioned communication method.

The wireless internet unit 113 refers to a module for wireless internet access and may be built in or externally attached to the user terminal 100. The wireless internet unit 113 may be configured to transmit and receive wireless signals in a communication network according to wireless internet technologies.

The wireless internet technology includes, for example, wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like. However, the present disclosure is not limited to the examples of the above-mentioned wireless internet technical standards.

The short-range communication unit 114 is used for local area communication and supports the local area communication by using at least one of Bluetooth™, Radio Frequency Identification (RFID), Infrared Data Association (IrDA), Ultra-wideband (UWB), ZigBee, Near Field Communication (NFC), wireless-fidelity (Wi-Fi), Wi-Fi Direct, and Wireless Universal Serial Bus (USB). However, the present disclosure is not limited to the examples of the above-mentioned local area communication methods.

The position information unit 115 is a module for obtaining the location (or current location) of the user terminal 100, and a representative example thereof includes a global positioning system (GPS) module or a wireless fidelity (WiFi) module. For example, when the user terminal 100 utilizes the GPS module, the user terminal 100 may obtain the location of the user terminal 100 by using a signal transmitted from a GPS satellite.

The location information of the user terminal 100 recorded by the position information unit 115 may be temporarily stored in the memory 170. As described later, this intends that, when the user requests the use of the plurality of washing machines 1000, the location information of the user terminal 100 is used in order that the cloud server 200 selects a commercial washing machine to be standby. Thereafter, the location information of the user terminal 100 may be transmitted to the cloud server 200 through the network 500.

The input unit 120 may include a camera 121 for inputting a video signal, a microphone 122 for receiving an audio signal, and a user input unit 123 for receiving information from the user.

The audio data or image data collected by the input unit 120 may be analyzed by the processor 180 and processed according to control commands of the user.

The input unit 120 is used to input video information (or signal) audio information (or signal), or information input from the user. For the purpose of inputting the video information, the user terminal 100 may include one or a plurality of cameras 121.

The camera 121 processes an image frame such as a still image or a video obtained by an image sensor in a video call mode or a capturing mode. The processed image frame may be displayed on a display unit 151 or stored in the memory 170.

The microphone 122 processes external sound signals into electrical audio data. The user terminal 100 may be provided with a voice command of the user through the microphone 122.

The processed audio data may be utilized in various ways according to a function (or an application program being executed) performed by the user terminal 100. Meanwhile, various noise reduction algorithms may be implemented in the microphone 122 in order to remove noises generated during receiving the external sound signals.

The user input unit 123 is used for receiving information from the user. When information is input through the user input unit 123, the processor 180 may control an operation of the user terminal 100 to correspond to the input information. Such a user input unit 123 may include a mechanical input means (or a mechanical key, such as a button, a dome switch, a jog wheel, a jog switch located at front and rear surfaces or side surface of the user terminal 100) and touch input means.

As an example, the touch input means may include a virtual key, a soft key, or a visual key displayed on the display unit 151 through a software process, or include a touch key disposed on a region other than the region where the display unit 151 is located. Meanwhile, the virtual key or the visual key can be displayed on the touch screen in various forms. For example, the virtual key or the visual key may consist of a graphic, a text, an icon, a video, or a combination thereof.

The learning processor 130 may be configured to receive, classify, store, and output information to be used for data mining, data analysis, intelligent decision making, and machine learning algorithms and technologies.

The learning processor 130 may include one or more memory units configured to store data received, detected, sensed, generated, predefined, or in another way output by the user terminal 100 using AI or data received, detected, detected, generated, predefined, or in another way output by another component, device, user terminal 100 or a device communicating with the user terminal 100.

The learning processor 130 may include a memory integrated with or implemented in the user terminal 100. In some embodiments, the learning processor 130 may be implemented by using the memory 170.

Optionally or additionally, the learning processor 130 may be implemented by using a memory related to the user terminal 100, for example, an external memory coupled directly to the user terminal 100 or a memory maintained in a server communicating with the user terminal 100.

In another embodiment, the learning processor 130 may be implemented by using a memory maintained in a cloud computing environment or by using another remote memory location accessible by the user terminal 100 through a communication method such as a network.

The learning processor 130 may be generally configured such that data is stored in one or more databases in order that the data is identified, indexed, categorized, manipulated, stored, retrieved and output for the purpose that data is used in supervised learning, unsupervised learning, reinforcement learning, data mining, predictive analytics or in other machines.

Through use of any of a variety of different types of data analysis algorithms and machine learning algorithms, the information stored by the learning processor 130 may be used by one or more other controllers of the user terminal 100 or the processor 180.

Examples of such algorithms include k-nearest neighbor system, fuzzy logic (e.g., probability theory), neural network, Boltzmann machine, vector quantization, pulse neural network, support vector machine, maximum margin classifier, hill climbing, inductive logic system Bayesian network, Petri Net (e.g., finite state machine, Mealy machine, Moore finite state machine), classifier tree (e.g., perceptron tree, support vector tree, Markov tree, decision tree forest, random forest), stake model and system, artificial fusion, sensor fusion, image fusion, reinforcement learning, augmented reality, pattern recognition, automated planning, and the like.

The processor 180 may control the operation of the user terminal 100 to correspond to the input information.

The processor 180 may determine or predict at least one executable operation of the user terminal based on information that is determined or generated by using a data analysis algorithm or a machine learning algorithm. To the end, the processor 180 may request, search, receive or utilize the data of the learning processor 130 and may control the user terminal such that operations which are predicted or are determined to be desirable among the at least one executable operation are performed.

The processor 180 may perform various functions for implementing intelligent emulation (i.e., a knowledge-based system, an inference system, and a knowledge acquisition system). The functions may be applied to various types of systems (e.g., fuzzy logic systems), including adaptive systems, machine learning systems, artificial neural networks, and the like.

The processor 180 may also include sub-modules that enable operations involving audio and natural language voice processing, such as an I/O processing module, an environmental condition module, a speech-to-text (STT) processing module, a natural language processing (NLP) module, a workflow processing module, and a service processing module.

Each of these submodules may have access to one or more systems, or data and model, or a subset or super set thereof, in an audio recognition device. In addition, each of these submodules may provide various functions, including lexical index, user data, workflow model, service model, and automatic speech recognition (ASR) system.

According to another embodiment, other aspects of the processor 180 or the user terminal 100 may be implemented with the submodule, system, or data and model.

According to some embodiments, based on data of the learning processor 130, the processor 180 may be configured to detect requirements based on a user's intention or a contextual condition expressed in user input or natural language input.

The processor 180 may actively derive and obtain the information required to fully determine the requirements based on the contextual condition or the user's intention. For example, the processor 180 may actively derive the information required to determine the requirements by analyzing historical data, including historical input and output, pattern matching, unambiguous words, input intent, and the like.

The processor 180 may determine a flow of tasks for executing a function in response to the requirement based on the contextual condition or the user's intention.

The processor 180 collects, detects, extracts, and/or receives signals or data used for data analysis and machine learning tasks through one or more sensing components in the user terminal to collect information for processing and storage in the learning processor 130.

The information collection may include sensing information via a sensor, extracting information stored in memory 170, receiving information from another artificial intelligence device, entity, or external storage device via a communication means, and so on.

The processor 180 may collect and store use history information of the user terminal of the present disclosure. The processor 180 can use the stored use history information and predictive modeling to determine the best match in which a particular function is executed.

The processor 180 may receive or detect surrounding environment information or other information through the sensing unit 140.

The processor 180 may receive a broadcast signal and/or broadcast related information, a wireless signal, and wireless data through the wireless communication unit 110

The processor 180 may receive image information (or a corresponding signal), audio information (or a corresponding signal), data, or user input information from the input unit 120.

The processor 180 collects information in real time, processes or classifies the information (e.g., knowledge graph, command policy, personalization database, conversation engine, etc.), and stores the processed information in the memory 170 or the learning processor 130.

When the operation of the user terminal 100 is determined based on data analysis and machine learning algorithms and techniques, the processor 180 may control components of the user terminal 100 to perform the determined operation. The processor 180 may control the equipment according to the control command, thereby performing the determined operation.

When a specific operation is executed, the processor 180 analyzes historical information indicating execution of the specific operation through data analysis and machine learning algorithms and techniques, and updates the previously learned information based on the analyzed information.

Accordingly, the processor 180 may improve accuracy of future performance of data analysis and machine learning algorithms and techniques based on the updated information, together with the learning processor 130.

The sensing unit 140 may include one or more sensors for sensing at least one of information in the user terminal 100, surrounding environment information surrounding the user terminal 100, and user information.

For example, the sensing unit 140 may include at least one of a proximity sensor 141, an illumination sensor 142, a touch sensor, an acceleration sensor, a magnetic sensor, a gravity sensor, a gyroscope sensor, motion sensor, RGB sensor, infrared sensor (IR sensor), fingerprint scan sensor, ultrasonic sensor, optical sensor (e.g., camera, see 121), microphones (e.g., see 122), battery gauges, environmental sensors (e.g. barometers, hygrometers, thermometers, radiation sensors, heat sensors, gas sensors, etc.), chemical sensors (e.g. an electronic nose, a healthcare sensor, a biometric sensor, etc.). Meanwhile, the user terminal 100 disclosed in the present disclosure may use a combination of information detected by at least two or more of these sensors.

The output unit 150 is used to generate outputs related to visual, auditory, or tactile senses, and includes at least one of a display unit 151, an sound output unit 152, a haptic module 153, and a optical output unit 154.

The display unit 151 displays (outputs) information processed by the user terminal 100. For example, the display unit 151 may display execution screen information of an application program operated in the user terminal 100, or user interface (UI) and graphic user interface (GUI) information according to the execution screen information.

The display unit 151 is structured in a manner as to have a layer structure with a touch sensor or be integrally formed with a touch sensor, thereby implementing a touch screen. The touch screen may function as a user input unit 123 providing an input interface between the user terminal 100 and the user, while providing an output interface between the user terminal 100 and the user.

Particularly, the display unit 151 according to some embodiments of the present disclosure may function as an interface which receives an input of the user in order that the user terminal 100 performs the control of the commercial washing machine 1000.

Details of the operation of the commercial washing machine 100, for example, the type of a washing process, a washing time, and an amount of detergent, which are included in the washing course to be performed by the commercial washing machine 1000 may be displayed through the display unit 151. The user inputs a start command or a modified washing course to the display unit 151, and thus, the commercial washing machine can be controlled.

The sound output unit 152 may output audio data received from the wireless communication unit 110 or stored in the memory 170 in a call signal reception mode, a call mode, a recording mode, a voice recognition mode, a broadcast reception mode, and the like. The sound output unit 152 may include at least one of a receiver, a speaker, and a buzzer.

The haptic module 153 generates various tactile effects that a user can feel. A representative example of the tactile effect generated by the haptic module 153 may include vibration.

The optical output unit 154 outputs a signal for notifying event occurrence by using light from a light source of the user terminal 100. Examples of events occurring in the user terminal 100 may include message reception, call signal reception, a missed call, an alarm, a schedule notification, email reception, information reception through an application, and the like.

The interface unit 160 serves as a path to various types of external devices connected to the user terminal 100. The interface unit 160 may include at least one of a wired/wireless headset port, an external charger port, a wired/wireless data port, a memory card port, port connecting a device equipped with an identification module, an audio input/output (I/O) port, a video input/output (I/O) port, and an earphone port. In response to the connection of the external device to the interface unit 160, the user terminal 100 may perform appropriate control related to the connected external device.

Meanwhile, the identification module is a chip that stores a variety of information for authenticating the use rights of the user terminal 100, and includes a user identification module (UIM), subscriber identity module (SIM), universal subscriber identity module (USIM), and the like. The device equipped with the identification module (hereinafter referred to as an “identification device”) may be manufactured in the form of a smart card. Therefore, the identification device may be connected to the user terminal 100 through the interface unit 160.

The memory 160 stores data supporting various functions of the user terminal 100.

The memory 170 may store multiple application programs or applications that are driven in the user terminal 100, data used for operating the user terminal 100, instructions, and data used for operation of the learning processor 130 (e.g., at least one algorithm information for machine learning, etc.).

The memory 170 may include a volatile memory or a nonvolatile memory. The nonvolatile memory includes Read Only Memory (ROM), Programmable ROM (PROM), Electrically Programmable ROM (EPROM), Electrically Erasable and Programmable ROM (EEPROM), Flash Memory, Phase-change RAM (PRAM), Magnetic RAM (MRAM), Resistive RAM (RRAM), Ferroelectric RAM (FRAM), etc. The volatile memory may include at least one of various memories such as Dynamic RAM (DRAM), Static RAM (SRAM), Synchronous DRAM (SDRAM), Phase-change RAM (PRAM), Magnetic RAM (MRAM), Resistive RAM (RRAM), Ferroelectric RAM (FeRAM), etc.

The processor 180 typically controls the overall operation of the user terminal 100 in addition to the operations associated with the application program. The processor 180 may process signals, data, information, or the like input or output through the above-described components or operate the application program stored in the memory 170, thereby providing or processing information or functions that are suitable for the user.

In addition, the processor 180 may control at least some of the components described with reference to FIG. 1 to operate the application program stored in the memory 170. In addition, the processor 180 may operate a combination of at least two of the components included in the user terminal 100 in combination with each other to run the application program.

The power supply unit 190 may supply power to each component included in the user terminal 100 by receiving an external power source or an internal power source under the control of the processor 180.

The power supply unit 190 includes, for example, a battery, which may be a built-in battery or a replaceable battery. On the other hand, the power supply unit 190 may be an adaptor which receives an alternate current power and converts it into a direct current power, and then supplies to the user terminal 100.

In the meantime, as described above, the processor 180 typically controls the overall operation of the user terminal 100 in addition to the operations associated with the application program. For example, when the state of the user terminal 100 satisfies a set condition, the processor 180 may execute or release a locked state that restricts an input of a user's control command to the applications.

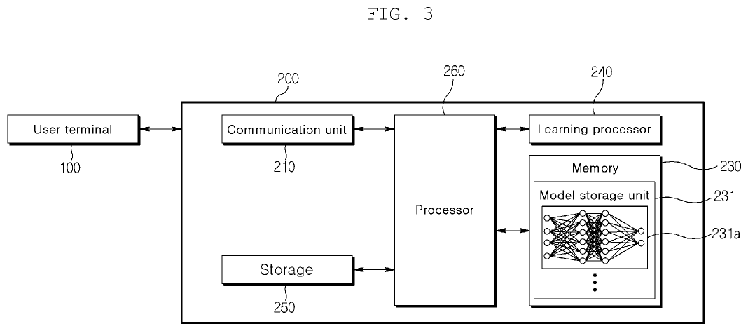

FIG. 3 is a view for describing the cloud server 200 included in the control system for the commercial washing machine according to some embodiments of the present disclosure.

Referring to FIG. 3, the cloud server 200 may include a communication unit 210, an input unit 220, a memory 230, a learning processor 240, a storage 250, and a processor 260.

The communication unit 210 may correspond to a configuration including the wireless communication unit 110 and the interface unit 160 included in the user terminal 100 of FIG. 2. That is, the communication unit 210 may transmit/receive data to/from other devices through wired/wireless communication or an interface.

The input unit 220 corresponds to the input unit 120 of FIG. 2 and may obtain data by receiving data from the communication unit 210.

The input unit 220 may obtain a training data for model learning and obtain an input data, etc., for obtaining an output by using a trained model.

The input unit 220 may obtain raw input data. In this case, the processor 260 may pre-process the obtained data and thus may generate a training data that can be input to model learning or a pre-processed input data.

Here, the pre-processing of the input data performed by the input unit 220 may mean that an input feature is extracted from the input data.

The memory 230 corresponds to the memory 170 of FIG. 2. The memory 230 may include a model storage unit 231, a database 232, etc. The memory 230 may temporarily store data processed by the processor 260.

The model storage unit 231 stores a model (or an artificial neural network 231a) which is being trained or has been trained through the learning processor 240. When the model is updated through learning, the model storage unit 231 stores the updated model.

Here, if necessary, the model storage unit 231 may store the trained models with the division of the trained models into a plurality of versions according to the learning time point or the degree of learning progress.

The artificial neural network 231a shown in FIG. 3 is just an example of an artificial neural network including a plurality of hidden layers. The artificial neural network of the present disclosure is not limited to this.

The artificial neural network 231a may be implemented with hardware, software or a combination of hardware and software. When the artificial neural network 231a is partially or wholly implemented in software, one or more instructions constituting the artificial neural network 231a may be stored in the memory 230.

The database 232 may store the input data obtained by the input unit 220, the learning data (or training data) used for the model learning, the learning history of the model, etc.

The input data stored in the database 232 may be not only processed data suitable for the model learning but also a raw input data itself.

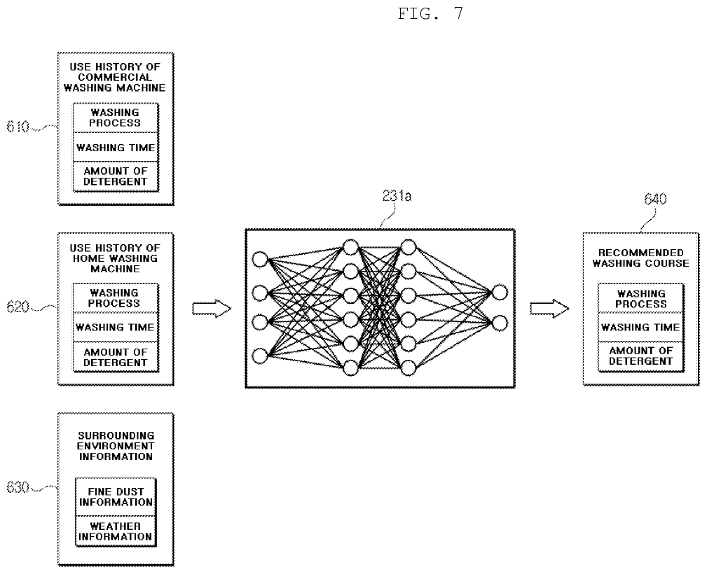

The cloud server 200 included in the control system for the commercial washing machine according to some embodiments of the present disclosure may store a user's use history of the commercial washing machine. The user's use history of the commercial washing machine stored in the server 200 and the creation of the recommended washing course using the same will be described later in more detail with reference to FIG. 7.

The learning processor 240 corresponds to the learning processor 130 of FIG. 2. The learning processor 240 may train the artificial neural network 231a by using the training data or a training set.

The learning processor 240 trains the artificial neural network 231a by obtaining immediately data obtained by the processor 260 which has pre-processed the input data obtained through the input unit 220, or trains the artificial neural network 231a by obtaining the pre-processed input data stored in the database 232.

Specifically, the learning processor 240 trains repeatedly the artificial neural network 231a by using the above-described various learning methods, thereby determining optimized model parameters of the artificial neural network 231a.

In this specification, the artificial neural network which is trained by using the training data and has hereby a determined parameter may be referred to as a learning model or a trained model.

Here, the learning model may infer a result value in the state of being mounted on the cloud server 200 of the artificial neural network, or may be transmitted to another device such as the user terminal 100 through the communication unit 210 and mounted.

Also, when the learning model is updated, the updated learning model may be transmitted to another device such as the user terminal 100 through the communication unit 210 and mounted. The storage 250 may store programs and data required for the operation of the cloud server 200. The storage 250 may store, for example, program data related to a control command corresponding to a washing course of the commercial washing machine, and may provide the program data to the memory 230 when the corresponding program is executed by the processor 260.

Also, the storage 250 may store data related to a user account and use history of the commercial washing machine registered for each user. As described later, the cloud server 200 may create the recommended washing course by using the use history of the commercial washing machine stored in the user account. The processor 260 may load information on the use history of the commercial washing machine stored in the user account from the storage 250 and may provide the information to the memory 230.

In addition, the cloud server 200 may evaluate the artificial intelligence model, may update the artificial intelligence model for better performance even after the evaluation, and may provide the updated artificial intelligence model to the user terminal 100. Here, the user terminal 100 may perform alone in a local area a series of steps performed by the cloud server 200 or perform together with the cloud server 200 through the communication with the cloud server 200.

For example, the user terminal 100 may update the artificial intelligence model downloaded from the cloud server 200 by allowing the artificial intelligence model to learn a personal pattern of the user through the learning of the user's personal data.

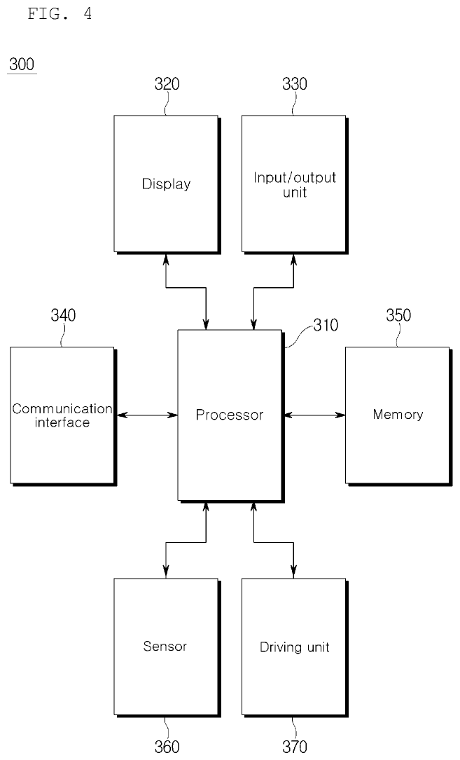

FIG. 4 is a view for describing a commercial washing machine 300 included in the control system of a commercial washing machine according to some embodiments of the present invention.

The commercial washing machine 300 is included in the plurality of commercial washing machines 1000 described with reference to FIG. 1. Also, the contents described below may be applied to all of the plurality of commercial washing machines 1000.

Referring to FIG. 4, the commercial washing machine 300 included in the control system of a commercial washing machine according to some embodiments of the present invention may include a processor 310, a display 320, an input/output unit 330, a communication interface 340, a memory 350, a sensor 360, and a driving unit 370.

The processor 310 may control the operation of the commercial washing machine 300. Specifically, when a control command of the commercial washing machine 300 is provided through the communication interface 340 connected to the cloud server 200 or the user terminal 100, the processor 310 may control the operation of the commercial washing machine 300 based on the corresponding control command.

The display 320 may display an internal state or data of the commercial washing machine 300. In some embodiments, the user may control the home appliance 300 through the user interface displayed on the display 320.

The input/output unit 330 may include at least one of an input unit and/or an output unit. The input unit includes a camera for video signal input, a microphone for receiving an audio signal, etc. The output unit includes an sound output unit, a haptic module, and a optical output unit which are for generating an output related to a visual sense, an auditory sense, or a tactile sense, etc.

The communication interface 340 may include a transmitter and a receiver. The commercial washing machine 300 may be connected to the user terminal 100 or the cloud server 200 by accessing the network 500 through the communication interface 340.

The commercial washing machine 300 connected to the user terminal 100 or the cloud server 200 may receive a control command required for driving the commercial washing machine 300 through the communication interface 340.

The communication interface 340 may use wireless internet standards, for example, a wireless LAN (WLAN), a wireless-fidelity (Wi-Fi), a wireless fidelity (Wi-Fi) direct, a digital living network alliance (DLNA), a wireless broadband (WiBro), and a WiMAX (World) Wireless Internet standards such as Interoperability for Microwave Access (HSDPA), High Speed Downlink Packet Access (HSDPA), High Speed Uplink Packet Access (HSUPA), Long Term Evolution (LTE), and Long Term Evolution-Advanced (LTE-A), and the like. However, the present disclosure is not limited by the examples of wireless Internet technical specifications described above.

The memory 350 may include a volatile memory or a nonvolatile memory. The nonvolatile memory includes Read Only Memory (ROM), Programmable ROM (PROM), Electrically Programmable ROM (EPROM), Electrically Erasable and Programmable ROM (EEPROM), Flash Memory, Phase-change RAM (PRAM), Magnetic RAM (MRAM), Resistive RAM (RRAM), Ferroelectric RAM (FRAM), etc. The volatile memory may include at least one of various memories such as Dynamic RAM (DRAM), Static RAM (SRAM), Synchronous DRAM (SDRAM), Phase-change RAM (PRAM), Magnetic RAM (MRAM), Resistive RAM (RRAM), Ferroelectric RAM (FeRAM), etc.

The sensor 360 may include, for example, a proximity sensor, an illumination sensor, a touch sensor, an acceleration sensor, a magnetic sensor, and a gravity sensor (G-sensor), a gyroscope sensor, a motion sensor, a RGB sensor, an infrared sensor (IR sensor), a fingerprint scan sensor, an ultrasonic sensor, an optical sensor, etc. However, the sensor 360 is not limited thereto.

In particular, the sensor 360 may include a temperature sensor for measuring a temperature within a washing tank included in the commercial washing machine 300, a weight sensor for measuring the amount of detergent, and the like.

The driving unit 370 may perform mechanical or electrical operations required to drive the commercial washing machine. The driving unit 370 may receive laundry and may perform operations required for the washing process controlled by the processor 310. The driving unit 370 may include, for example, a washing tank for receiving laundry, a motor for rotating the washing tank during the washing process, a pump for supplying water to the washing tank, and the like. However, the driving unit 370 is not limited thereto.

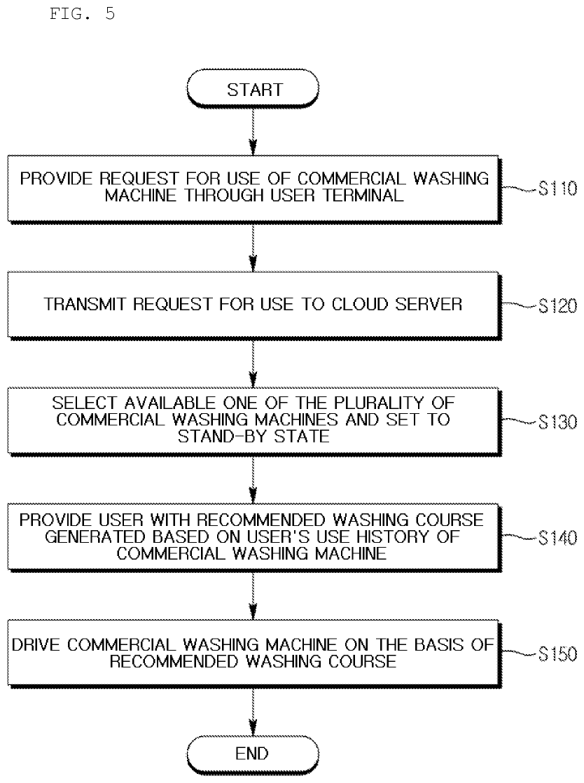

FIG. 5 is a flowchart for describing a method for controlling a commercial washing machine in accordance with some embodiments of the present disclosure. As described in more detail below, the method for controlling a commercial washing machine in accordance with some embodiments of the present disclosure may be performed by the user terminal 100, the cloud server 200, and the commercial washing machine 300. For example, each step of the method for controlling a commercial washing machine may be performed by the processor 180 of the user terminal 100 and the processor 260 of the server 200.

Referring to FIG. 5, a request for use of a commercial washing machine is provided through the user terminal (S110).

The plurality of commercial washing machines 1000 may receive the request for use from people who want to use the washing machine, and may wash the laundry of the user whose reservation has been completed. The reservation for use means an operation to exclude the use of other people other than the user in order to use any one of the plurality of commercial washing machines 1000 now or at a particular point of time in the future.

When there is a request for use of any one of the plurality of commercial washing machines 1000 from the user, the cloud server 200 collects state information of the plurality of commercial washing machines 1000. Then, the cloud server 200 may make a reservation for use of an available commercial washing machine.

The user may use the user terminal 100 in order to request the use of the commercial washing machine 1000. The request for use may be performed by the user terminal 100 accessing the cloud server 200. An authentication process for a user may be performed to reserve the use of the commercial washing machine 1000. The user authentication may be performed by a process of logging into the user account which exists on the cloud server 200 through the user terminal 100.

In some embodiments, the request for use and reservation for use of the commercial washing machine may be performed through an application executed on the user terminal 100.

The user terminal 100 may receive, from the user on the application, details regarding the request for use of the commercial washing machine, for example, conditions such as reserved time for use, the amount of laundry, and the like.

When the user terminal 100 is a smartphone, the user terminal 100 may receive an input through the user input unit 123 including a touch interface. However, the user terminal is not limited thereto. Alternatively, when a voice input requesting the use of the commercial washing machine 1000 is provided from the user, the user terminal 100 may receive the request for use in the form of a voice signal through the microphone 122.

Subsequently, the user terminal 100 may transmit the provided request for use of the commercial washing machine 1000 to the cloud server 200 (S120).

The user terminal 100 may transmit information on the time for use of the commercial washing machine 1000 and the amount of laundry to be washed, etc., to the cloud server 200 together with the request for use of the commercial washing machine 1000.

In addition, the user terminal 100 may provide state information of the user to the cloud server 200 together with the request for use. The user status information may be, for example, location information of the user.

When the position information unit 115 of the user terminal 100 obtains the location information of the user terminal 100, the user terminal 100 may transmit the location information of the user terminal 10 to the cloud server 200 together with the request for use.

In some other embodiments of the invention, the location information of the user may be obtained by the user input. The user inputs directly his/her current location to the user terminal 100 or the location of the commercial washing machine that the user wants to use, so that location information to be provided to the cloud server 200 may be obtained.

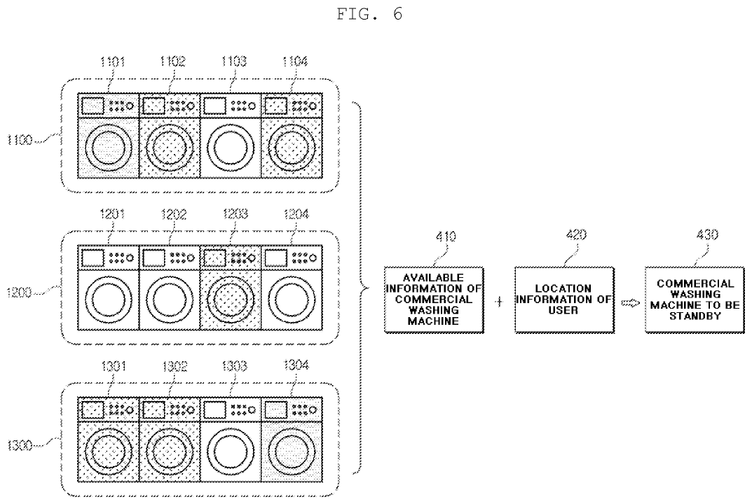

Subsequently, the cloud server 200 selects an available one of the plurality of commercial washing machines based on the request for use and sets the commercial washing machine to a standby state (S130). This will be described in more detail with reference to FIG. 6.

FIG. 6 is a view for describing that the control system for a commercial washing machine by using artificial intelligence in accordance with some embodiments of the present disclosure sets the commercial washing machine to a standby state.

Referring to FIG. 6, first to third plurality of commercial washing machines 1100 to 1300 are shown. As described above, the first to third plurality of commercial washing machines 1100 to 1300 are placed in different spaces, respectively. That is, the first to third plurality of commercial washing machines 1100 to 1300 may be respectively placed in launderettes located at mutually different distances from the user.

For user request for use of the commercial washing machine, the cloud server 200 may refer to available information 410 of the plurality of commercial washing machines 1100, 1200, and 1300. The available information 410 means information on the commercial washing machines available among the plurality of commercial washing machines 1000 connected through the cloud server 200 and the network 500.

The commercial washing machines 1102, 1104, 1203, 1301, and 1302 marked with shade in FIG. 6 are examples of washing machines in use by other users. These commercial washing machines are classified as commercial washing machines that cannot be used at a point of time when the request for use is provided, because they can be used after the washing course in progress is completely finished.

In addition, a commercial washing machine that is not currently in use and has a reservation for use set by the request for use of another user may be included in the plurality of commercial washing machines 1100, 1200, and 1300. This is illustratively shown as commercial washing machines 1101 and 1304 marked with another shade in FIG. 6. The corresponding commercial washing machine is also classified as a commercial washing machine that cannot be used at a time point of user request for use.

The commercial washing machines 1000 may notify the cloud server 200 when the washing course set by the user starts or ends. The cloud server 200 may update information on the use state of the commercial washing machine 1000 based on the start or end of the washing course notified by the commercial washing machines 1000.

The washing machines 1103, 1201, 1202, 1204, and 1303 illustratively shown as available in FIG. 6 are classified as commercial washing machines that are currently available, that is, are in a state where a reservation for use can be set. Therefore, the cloud server 200 may select one of these washing machines 1103, 1201, 1202, 1204, and 1303.

When a request for use of the commercial washing machine 1000 is provided by the user, the cloud server 200 make reference to the state information of the user who provides the request for use, for example, the location information 420 of the user, and perform a reservation for use of an available commercial washing machine 1000. For example, it is assumed that launderettes that are the closest to the current location of the user who provides the request for use are a second launderette, a first launderette, and a third launderette in sequence.

The cloud server 200 may select an available one among the commercial washing machines located closest to the user. The cloud server 200 may select one of the second commercial washing machines 1201, 1202, and 1204 available for the request for use and may set it to a standby state.

Alternatively, when neither of the commercial washing machines of the second launderette are not available unlike what is shown in FIG. 6, the commercial washing machine 1103 of the first launderette located next closest to the user may be selected and set to the standby state (430).

The cloud server 200 may update the available information 410 of the commercial washing machine while selecting the commercial washing machine to be standby. The state information of the standby commercial washing machine may be changed into the state of having been reserved by the user on the available information 410 of the commercial washing machine.

The cloud server 200 may turn on the power while setting the selected commercial washing machine to the standby state. The standby commercial washing machine may be set to a locked state such that a user other than the user who has requested the use cannot use the commercial washing machine. In the locked state, the input/output unit 330 of the commercial washing machine may be locked and thus cannot be operated, or the door of the washing tank of the commercial washing machine 300 may be locked. In order to release this, an authentication process between the user terminal 100 and the cloud server 200 or the commercial washing machine 300 may be required.

Subsequently, the recommended washing course is created based on the user's use history of the commercial washing machine and is provided to the user (S140). This will be described in more detail with reference to FIG. 7.

FIG. 7 is a view for describing that the control system for a commercial washing machine in accordance with some embodiments of the present disclosure creates the recommended washing course.

Referring to FIG. 7, the cloud server 200 may use a use history 610 of the commercial washing machine in order to create a recommended washing course to be provided to a user.

The user's use history 610 of the commercial washing machine may include the use history of the plurality of commercial washing machines 1000 connected by the network 500. That is, the use history 610 of the commercial washing machine may include all the use histories of the plurality of commercial washing machines 1000 which are connected through the network 500 and are located in different spaces.

The user's use history 610 of the commercial washing machine may be stored in the user accounts on the cloud server 200, respectively. The use history 610 of the commercial washing machine may include, for example, a washing process, a washing time, and an amount of detergent that the user selected while using the commercial washing machine in the past.

The cloud server 200 may extract features from the user's use history 610 of the commercial washing machine in order to create the recommended washing course. For example, the cloud server 200 may extract features from the user's use history 610 of the commercial washing machine by using the artificial neural network 231a. As a result of learning based on feature information of the user's use history, the recommended washing course suitable for the user may be created.

In some embodiments of the present invention, the cloud server 200 may create the recommended washing course by using a use history 620 of the washing machine in the user's home. The use history 620 of the washing machine in the user's home may include, for example, a washing process, a washing time, and an amount of detergent that the user selected while using the washing machine in the home in the past.

A household washing machine possessed by the user may be a different model from the commercial washing machines connected by the network 500. Therefore, in the creation of the recommended washing course to be used in the commercial washing machine used by the user, the importance of the use history of the household washing machine may be lower than the importance of the use history of the commercial washing machine. In order to reflect this, when creating the recommended washing course of the commercial washing machine, the user's use history 620 of the household washing machine may have a lower weight than that of the user's use history 610 of the commercial washing machine.

The cloud server 200 may extract features from the user's use history 620 of the household washing machine in order to create the recommended washing course, and may create the recommended washing course suitable for the user as a result of learning based on the extracted feature information.

Meanwhile, the cloud server 200 may create the recommended washing course based on the user's surrounding environment information 630. The user's surrounding environment information 630 may include, for example, fine dust information and weather information. The cloud server 200 may obtain the user's surrounding environment information 630 based on the location information of the user provided from the user terminal 100.

For example, it is assumed that fine dust around the user is increased more than usual. Here, in the creation of the recommended washing course, the cloud server 200 may increase the time for washing and rinsing courses to create a recommended washing course that can respond to a case where there is a large amount of fine dust on the laundry.

Also, it is assumed that it rains continuously according to weather information of the user's surroundings. Here, in the creation of the recommended washing course, the cloud server 200 may create a recommended washing course including an increased dry course time such that the laundry does not get damp.

The cloud server 200 using the user's surrounding environment information is not limited to the above example. The user's surrounding environment information, together with the use history 610 of the commercial washing machine or the use history 620 of the household washing machine, may be input to the artificial neural network 231a and may be used to create the recommended washing course.

The recommended washing course 640 created for the commercial washing machine through the above-described process may be provided to the user. Then, commercial washing machine may be driven based on the recommended washing course (S150).

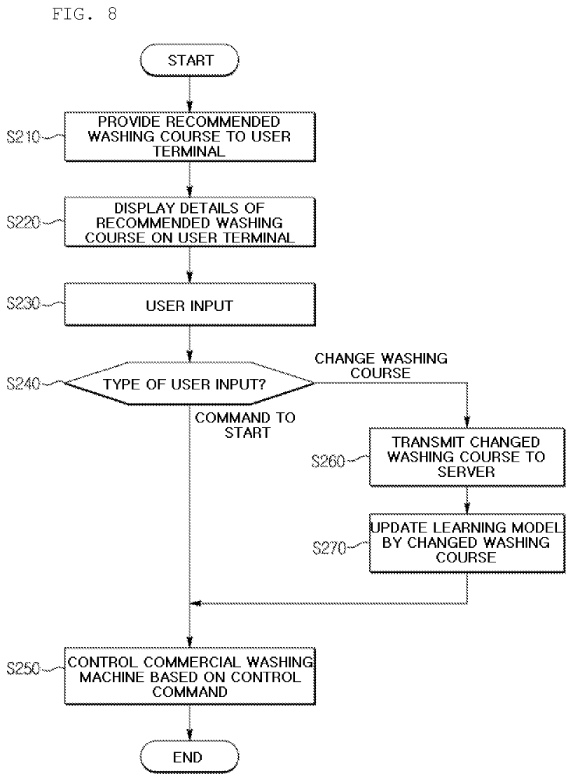

The control of the commercial washing machine using the recommended washing course will be described in more detail with reference to FIG. 8.

FIG. 8 is a flowchart for describing the method for controlling the commercial washing machine in accordance with some embodiments of the present disclosure.

Referring to FIG. 8, a recommended washing course is provided to the user terminal (S210).

When the cloud server 200 creates a recommended washing course, the recommended washing course is provided to the user terminal 100. Subsequently, the display unit 151 of the user terminal 100 displays the details of the recommended washing course (S220).

For example, the display unit 151 may display the washing process, the washing time, and the amount of detergent to be added, in the recommended washing course.

The user may provide user inputs for the recommended washing course through the interface unit 160 of the user terminal 100 (S230). For example, the user may provide user inputs through a touch screen of the display unit 151 of the user terminal 100.

The user terminal 100 determines the type of the provided user input (S240). When the provided user input is intended to start performing the recommended washing course of the commercial washing machine, a control command which is generated based on the recommended washing course and is to start the commercial washing machine may be provided to the commercial washing machine (S250).

When the user input provided to the user terminal 100 is intended to change the washing course, the user terminal 100 may create a changed washing course based on the user input. The user terminal 100 may start the commercial washing machine based on the changed washing course, and may transmit the changed washing course to the cloud server 200 (S260).

The cloud server 200 may update the learning model for creating the recommended washing course by using the provided washing course (S270). Then, when there is a request for use of another commercial washing machine from the user, the cloud server 200 may create a recommended washing course by using the updated learning model.

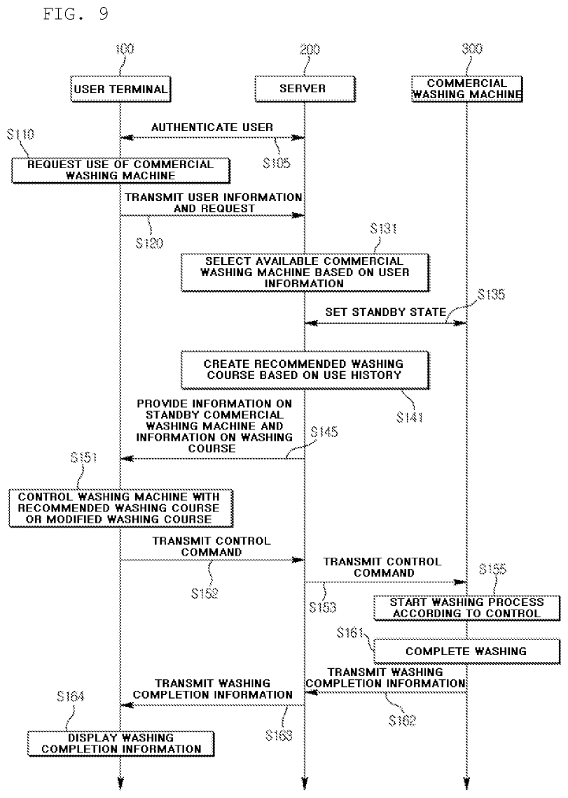

FIG. 9 is a data flowchart for describing the method for controlling by using the commercial washing machine accordance with some embodiments of the present disclosure.

Referring to FIG. 9, user authentication is performed between the user terminal 100 and the cloud server 200 (S105). The user authentication process may be performed on an application executed in the user terminal 100. The user may use various methods for the user authentication, for example, password input, face recognition, or fingerprint recognition, etc.

Subsequently, a request for use of the commercial washing machine is provided from the user to the user terminal 100 (S110). The user terminal 100 may receive, from the user, not only the request for use of the commercial washing machine but also conditions such as reserved time for use, the amount of laundry, and the like.

The user terminal 100 provides the cloud server 200 with the user information as well as the request for use (S120). The user information may include, for example, location information obtained through the position information unit 115 of the user terminal 100.

The cloud server 200 selects an available commercial washing machine based on the user information (S131). For the selection of the available washing machine, the cloud server 200 may use the use state of the plurality of commercial washing machines 300 connected to the network 500. Also, the cloud server 200 may select an available commercial washing machine located closest to the user based on the foregoing location information provided from the user terminal 100.

The cloud server 200 may set the selected commercial washing machine to a standby state (S135). The power of the standby commercial washing machine may be set to an on state, and the standby commercial washing machine may be set to a locked state such that a user other than the user who has requested the use cannot use commercial washing machine.

The cloud server 200 creates a recommended washing course based on the user's use history of the commercial washing machine and/or household washing machine (S141). The cloud server 200 may create a recommended washing course by generating a learning model with features extracted from the user's use history and by outputting the generated learning model.

The cloud server 200 provides the user terminal 100 with the information on the standby commercial washing machine and information on the created recommended washing course (S145). Information on the launderette where the standby commercial washing machine is located and information such as a standby commercial washing machine number within the launderette, or the like may be provided to the user through the user terminal 100.

When the user gives, through the user terminal 100, an operation command using the washing course or a washing course modified through the input, the user terminal 100 controls the commercial washing machine 300 with the recommended washing course or the modified washing course (S151).

When the commercial washing machine 300 is set to a locked state while being setting to a standby state, the user authentication using the user terminal 100 may be performed once again. The user authentication may be performed between the user terminal 100 and the cloud server 200.

Alternatively, the user authentication may be performed by communication between the commercial washing machine 300 and the short-range communication unit 114 of the user terminal 100. For example, the communication between the user terminal 100 and the commercial washing machine 300 may be directly performed by using a communication function of the short-range communication unit 114, for example, Bluetooth or NFC communication.

After the user authentication is completed, the locked state of the commercial washing machine 300 is released. Then, the input/output unit 330 of the commercial washing machine 300 can be used or the door of the washing tank can be opened.

The user terminal 100 transmits a control command to the cloud server 200 or the commercial washing machine 300 (S152, S153). The commercial washing machine 300 provided with the control command starts the washing process according to the control (S155).

The cloud server 200 may update the available information 410 of the commercial washing machine when the washing process is started. The state information of the commercial washing machine which has started the washing process may be changed into a state where the commercial washing machine is in use by the user on the available information 410 of the commercial washing machine.

The commercial washing machine 300 completes the washing (S161) and transmits washing completion information to the cloud server 200 (S162). The cloud server 200 may receive the washing completion information of the commercial washing machine 300 and may update the available information 410 of the commercial washing machine to indicate that the commercial washing machine which has completed the washing can be used.

The cloud server 200 transmits the washing completion information to the user terminal 100 in order to inform the user whether the washing is completed (S163). The user terminal 100 displays the washing completion information through the display unit 151 (S164).

The method for controlling a commercial washing machine by using artificial intelligence and the system for the same in accordance with the embodiment of the present disclosure reserve the use of the commercial washing machine to be used through the cloud server 200 in response to a user's request for use. Therefore, through this, it is possible to increase the convenience of a user who wants to use the commercial washing machine and to improve the user experience.

Also, the cloud server 200 may create and provide a recommended washing course applicable to the commercial washing machine to the user. Since the recommended washing course is created based on a user's past use history of a commercial washing machine or a household washing machine, it is possible to provide a recommended washing course suitable for use habit of the user.

The present disclosure described above can be implemented with computer readable codes on a medium on which a program is recorded. The computer-readable medium includes all types of recording devices in which data readable by a computer system is stored. Examples of computer-readable media include a hard disk drive (HDD), solid state disk (SSD), silicon disk drive (SDD), ROM, RAM, CD-ROM, magnetic tape, floppy disk, and optical data storage device, etc. Also, the computer may include the processor 180 of the equipment.

While the embodiment of the present invention has been described with reference to the accompanying drawings, it can be understood by those skilled in the art that the present invention can be embodied in other specific forms without departing from its spirit or essential characteristics. Therefore, the foregoing embodiments and advantages are merely exemplary and are not to be construed as limiting the present invention.

What is claimed is:

1. A method of a cloud server for controlling a plurality of commercial washing machines connected through network by using artificial intelligence, the method comprising:
receiving, from a user terminal, a request for use of a commercial washing machine;
selecting an available one of the plurality of commercial washing machines in response to the request for use;
setting the selected commercial washing machine to a standby state; and
providing the user terminal with a recommended washing course created based on a user's use history of the plurality of commercial washing machines.

2. The method of claim 1, further comprising:
authenticating the user terminal by logging into a user account registered in the cloud server in order to receive the request for use of a commercial washing machine,
wherein the user account stores the user's use history of the plurality of commercial washing machines.

3. The method of claim 2,
wherein the user account further stores a use history of a household washing machine possessed by the user,
and wherein the recommended washing course is generated further based on the user's use history of the household washing machine.

4. The method of claim 2,
wherein the plurality of commercial washing machines comprise a plurality of commercial washing machines located at different spaces,
and wherein the use history of the plurality of commercial washing machines comprises a use history of the plurality of commercial washing machines located at different spaces.

5. The method of claim 4, wherein selecting of an available one of the plurality of commercial washing machines comprises:
receiving location information of the user terminal; and
selecting an available one of the commercial washing machines located closest to the user terminal among the plurality of commercial washing machines located at different spaces.

6. The method of claim 1, wherein the providing the user terminal with a recommended washing course comprises:
extracting at least one feature from among a washing process, a washing time, and an amount of detergent comprised in the user's use history of the commercial washing machine; and
creating the recommended washing course from the extracted features.

7. The method of claim 1, further comprising controlling the standby commercial washing machine by using control commands based on the recommended washing course.

8. The method of claim 7, further comprising releasing a locked state of the commercial washing machine by using the user terminal in order to control the standby commercial washing machine.

9. A computer program stored in a computer-readable recording medium in order to perform the method of claim 1 by using a computer.

10. A control system for a plurality of commercial washing machines by using artificial intelligence, the control system comprising:
a plurality of commercial washing machines connected through a network; and
a cloud server configured to receive a request for use of the plurality of commercial washing machines from a user, select an available one of the plurality of commercial washing machines, and set the commercial washing machine to a standby state,
wherein the cloud server includes:
a storage which stores a user's use history of the plurality of commercial washing machines; and
a processor which creates a recommended washing course based on the user's use history of the plurality of commercial washing machines.

11. The control system of claim 10,
wherein the storage stores a user account into which the user logs in order to provide the request for use of the plurality of commercial washing machines,
and wherein the user account stores the user's use history of the commercial washing machine.

12. The control system of claim 11,
wherein the user account stores a user's use history of a household washing machine,
and wherein the processor creates the recommended washing course based on the user's use history of the household washing machine and the user's use history of the plurality of commercial washing machines.

13. The control system of claim 10, wherein the processor extracts at least one feature from among a washing process, a washing time, and an amount of detergent comprised in the user's use history of the washing machine, and creates the recommended washing course from the extracted features.

14. The control system of claim 10,
wherein the plurality of commercial washing machines comprise a plurality of commercial washing machines located at different spaces,
and wherein the use history of the plurality of commercial washing machines comprises a use history of the plurality of commercial washing machines located at different spaces.

15. The control system of claim 10, further comprising a user terminal which transmits the request for use of the plurality of commercial washing machines to the cloud server based on an input of the user,
wherein the user terminal comprises a display unit which outputs details by receiving the recommended washing course from the cloud server.

16. The control system of claim 15, wherein the user terminal controls the driving of the washing machine by receiving the input of the user and by transmitting control commands based on the recommended washing course to the standby commercial washing machine.

17. The control system of claim 16,
wherein the standby commercial washing machine is locked,
and wherein the user terminal performs user authentication, and thus releases the locked state of the commercial washing machine.

18. The control system of claim 15,
wherein the user terminal provides location information of the user to the cloud server,
and wherein an available one of the commercial washing machines located closest to the user among the plurality of available commercial washing machines located at different spaces based on the location information of the user is set to a standby state by the cloud server.
